(19) United States
(12) Patent Application Publication
(10) Pub. No.: US 2020/0370586 A1
(43) Pub. Date: Nov. 26, 2020

(54) FASTENING ASSEMBLY

(71) Applicant: Liya GE, Shenzhen (CN)

(72) Inventor: Liya GE, Shenzhen (CN)

(21) Appl. No.: 16/434,445

(22) Filed: Jun. 7, 2019

(30) Foreign Application Priority Data
May 24, 2019 (CN) 201920757229.8

(51) Int. Cl. F16B 21/06; B27F 5/02

(52) U.S. Cl. CPC F16B 21/06; B27F 5/02

(57) ABSTRACT

A fastening assembly having a sliding column and a sliding groove. The sliding column includes a fixing portion provided on a surface of a first installing member facing a second installing member, and an extending portion connected to the fixing portion. The sliding groove is formed on a surface of the second installing member facing the first installing member, and includes an avoiding space for inserting the extending portion into the sliding groove. A fastening space is provided for clamping the extending portion to the sliding groove. A bottom surface of the fastening space is formed with a locking hole. A limiting space is provided for limiting the extending portion from extending from the avoiding space to the fastening space.

### CROSS REFERENCE TO RELATED APPLICATIONS

The present application claims priority to Chinese Patent Application No. 201920757229.8, entitled “Fastening Assembly” (filed on May 24, 2019), the entire content of which is incorporated herein by reference in its complete entirety.

### TECHNICAL FIELD

The present disclosure relates to the field of connection assembly, and in particular, to a fastening assembly and an assembling device comprising the fastening assembly.

### BACKGROUND

In production and life, it is often necessary to assemble and connect two or more independent components in a predetermined position. Common connecting methods comprise welding, thread connection, snap connection, bonding, etc. During processing, according to the characteristics of the product, different connecting methods are selected.

At present, when users purchase furniture, closets or other similar products through the Internet, etc., they usually need to use specific installation tools or multiple instruction diagrams to complete the assembly of the products themselves; however, due to the limitations of the traditional assembly and connecting methods, many parts are required to be installed and the operation is cumbersome. The assembly process is often time-consuming and labor-intensive. The stability of the assembled product will vary from person to person, and even the newly purchased product may be damaged due to improper operation of the user.

A fastening device(s) for manufacturers of furniture, cabinets, store fixtures, closets and all items that are typically constructed from wood or plastic materials. In particular a device that will displace the traditional use of screws, bolts, nails, glue and other more commonly used joining systems available today in the market.

The market direction for most types of wood and plastic designed furniture, closets and similar product types is to sell them through the internet in what is typically referred to as “ready to assembly” or “knock down” configuration. This type configuration requires the consumer to assemble the product using tools and many pages of instructions. The result most often is not very user friendly to the general public purchasing these goods. Instructions can be confusing or not in the language of the purchaser. The assortment of different fastening components and which ones to use at what locations can be daunting. Of most distain to the average consumer is that the finished product is typically not very solid after final assembly and the time and effort to achieve the assembly was long and frustrating. Of additional concern is that the fasteners are visible and cheapen the look of the item and require frequent tightening so the product does not loosen up thus structural members become unstable and can wiggle out of position.

### SUMMARY

The purpose of the present disclosure is to provide a fastening assembly, an assembling device and a router tool, aiming to solve the technical problem that the unreasonable structure of the connecting member used in the product to be assembled in the prior art leads to a time-consuming and labor-intensive assembly process, poor stability of the finished product, and easy damage.

To achieve this purpose, the technical solution adopted by the disclosure is as follows:

The embodiments of the disclosure provide a fastening assembly for connecting the first installing member and the second installing member, which comprises:

a sliding column comprising a fixing portion provided on a surface of the first installing member facing the second installing member and an extending portion connected to the fixing portion, wherein the extending portion extends to the second installing member; and

a sliding groove for engaging and clamping with the extending portion; the sliding groove is formed on a surface of the second installing member facing the first installing member, the sliding groove has an avoiding space for inserting the extending portion into the sliding groove, a fastening space for clamping the extending portion to the sliding groove, and a limiting space for limiting the extending portion from extending from the avoiding space to the fastening space, a bottom surface of the fastening space is formed with a locking hole, and the avoiding space, the limiting space and the fastening space are connected in sequence.

Preferably, the extending portion comprises the first end connected to the fixing portion and the second end opposite to the first end, a receiving hole is formed on the outer end surface of the second end, the receiving hole is provided therein with a locking pin and an elastic member through which the locking pin is moved partially outside of the receiving hole, the outer end surface of the second end abuts against the bottom surface of the sliding groove when the extending portion slides in the sliding groove, and the locking pin is inserted into the locking hole under the pushing of the elastic member when the sliding column is located in the fastening space.

Preferably, the extending portion comprises an extending body and a protruding portion convexly provided on the outer wall of the extending body, the limiting space comprises the first limiting groove in which the extending body slides and the second limiting groove in which the protruding portion slides, and the first limiting groove and the second limiting groove are connected to each other.

Preferably, the extending body has a shape of cylinder, there are a plurality of protruding portions disposed on the extending body at intervals in axial direction of the extending body, each protruding portion is hemispherical, and the extending body and the plurality of protruding portions are arranged coaxially.

Preferably, the fixing portion comprises a fixing body and a plurality of pulling rings, and the fixing body is inserted into a receiving groove of the first installing member, the plurality of pulling rings are disposed on the fixing body at equal intervals in axial direction of the fixing body and respectively abuts against the groove walls of the receiving groove, so as to limit the fixing body withdrawn from the receiving groove.

Preferably, the sliding column further comprises a limiting portion which is located between the fixing portion and the extending portion for limiting the extending portion from entering the receiving groove, a limiting bevel corresponding to the limiting portion is formed at the notch of the sliding groove.

Furthermore, each of the pulling rings is boss-shaped and is disposed around an outer circumference of the fixing body.

Furthermore, the fixing portion further comprises an elastic body disposed on the fixing body and/or the pulling ring, and the elastic body comprises at least two elastic arms that abut against the groove wall of receiving groove.

Preferably, the fixing portion and the extending portion mirror each other, the fixing portion is located in the fixing groove, and the fixing groove is formed on a surface of the first installing member facing the second installing member.

Preferably, a screw locking hole corresponding to the through hole on the first installing member is formed on the end surface of the extending portion facing away from the fixing portion, and the fixing portion is lockedly connected to the first installing member by a screw.

The embodiments of the disclosure further provide a fastener comprising at least one extending portion, wherein the extending portion has the first end connected with another extending portion or a fixing portion or a screw and the second end opposite to the first end, a receiving hole is formed on the outer end surface of the second end, the receiving hole is provided therein with a locking pin capable of moving along the length direction of the receiving hole, and the extending portion has an extending body and a protruding portion convexly provided on the outer wall of the extending body.

Preferably, the receiving hole is further provided with an elastic member for partially pushing the locking pin outside of the receiving hole.

Preferably, the fastener comprises two extending portions which are arranged in mirror symmetry.

Preferably, the fastener comprises an extending portion and a fixing portion connected to the first end of the extending portion, and the fixing portion comprises a fixing body and a plurality of pulling rings.

Preferably, the fixing portion further comprises an elastic body arranged on the fixing body and/or the pulling ring, and the elastic body comprises at least two barbed elastic arms.

An embodiment of the disclosure further provides furniture or furniture parts comprising the above fastening assembly or fastener.

An embodiment of the disclosure further provides a router tool for processing a sliding groove, comprising a cutting portion, wherein the cutting portion is configured to insert into the second installing member in the first direction and translate and cut the second installing member in the second direction to form the sliding groove on a surface of the second installing member, and the sliding groove is configured to be engaged and clamped with the extending portion of the fastener provided by the present disclosure; the cutting portion comprises the first cutting edge for processing the first limiting groove and the second cutting edge for processing the second limiting groove, the first cutting edge has a cutting edge shape corresponding to a cross-sectional shape of the extending body, and the second cutting edge has a cutting edge shape corresponding to a cross-sectional shape of the protruding portion.

The disclosure provides a fastening assembly, which has the beneficial effects that: compared with the prior art, the disclosure provides a fastening assembly for connecting the first installing member and the second installing member; a sliding groove is provided on the second installing member by providing a sliding column in the first installing member. When assembling the first installing member and the second installing member, the user only needs to insert the sliding column into the avoiding space of the sliding groove and slide to the fastening space along the limiting space so as to securely fix and limit it in the sliding groove. In the process, the first installing member is translatable and slidable relative to the second installing member under the drive of the sliding column, finally realizing the stable connection with the second installing member; accordingly, the user does not need other additional installation tools when assembling the first installing member and the second installing member, the operation is simple, and the user installation process is not time-consuming or labor-intensive; the fastening assembly is provided so that the finished product quality does not vary from person to person, and the product is not easily damaged due to improper operation of the user; importantly, the structure ensures the connection stability of the finished product, prevents it from loosening over time, and prolongs the service life of the finished product.

The disclosure provides an assembling member, which has the beneficial effect that compared with the prior art, the assembling member provided by the disclosure comprises the first installing member, the second installing member and the above fastening assembly, and the structure is convenient to assemble, saves time and effort, and has sufficient connection strength and strong practicality.

The disclosure provides a router tool, which has the beneficial effect that compared with the prior art, the router tool provided by the disclosure is simple in structure, convenient to produce and process, available for providing sliding grooves in batches in various second installing members, strong in universality and high in production efficiency.

### BRIEF DESCRIPTION OF THE DRAWINGS

In order to more clearly illustrate the technical solutions in the embodiments of the disclosure, the drawings used in the embodiments or the prior art description will be briefly described below. Obviously, the drawings in the following description are merely some embodiments of the disclosure. Other drawings may also be obtained from the drawings by those skilled in the art without creative labor.

FIGS. 1(a), 1(b), 1(c), and 1(d) are a front view, a side view, a top view, and a bottom diagram illustrating a sliding column according to the first embodiment of the disclosure, respectively.

FIG. 2 is an exploded diagram illustrating a sliding column according to the first embodiment of the disclosure.

FIGS. 3(a), 3(b), and 3(c) are a front diagram illustrating a sliding column according to the first embodiment of the disclosure, a cross-sectional diagram of A-A in FIG. 3(a), and a cross-sectional diagram of B-B in FIG. 3(a), respectively.

FIG. 4 is a cross-sectional diagram illustrating a sliding column according to the first embodiment of the disclosure.

FIGS. 5(a), 5(b), and 5(c) are a schematic diagram prior to assembly, a schematic diagram in assembly, and a schematic diagram subsequent to assembly illustrating an assembling member according to the first embodiment of the disclosure, respectively.

FIG. 6 is a perspective diagram illustrating a sliding groove according to the first embodiment of the disclosure.

FIG. 7 is a plan diagram illustrating a sliding groove according to the first embodiment of the disclosure.

FIG. 8 is a schematic diagram illustrating the disassembly of the fastening assembly according to the first embodiment of the disclosure.

FIGS. 9(a) and 9(b) are a front diagram and a top diagram illustrating a sliding column according to the second embodiment of the disclosure, respectively.

FIG. 10 is a schematic diagram illustrating an assembling member according to the second embodiment of the disclosure prior to assembly.

FIG. 11 is a schematic diagram illustrating an assembling member according to the second embodiment of the disclosure subsequent to assembly.

FIGS. 12(a) and 12(b) are a front diagram and a bottom diagram illustrating a sliding column according to the third embodiment of the disclosure, respectively.

FIG. 13 is a plan diagram illustrating the first installing member and a sliding column according to the third embodiment of the disclosure.

FIG. 14 is a perspective diagram illustrating the first installing member and a sliding column according to the third embodiment of the disclosure.

FIG. 15 is a plan diagram illustrating a router tool according to an embodiment of the disclosure.

FIG. 16 is a flow chart illustrating processing a sliding groove by a router tool according to an embodiment of the disclosure.

### DESCRIPTION OF THE EMBODIMENTS

The embodiments of the disclosure are described in detail below, and the examples of the embodiments are illustrated in the drawings, wherein the same or similar reference numerals are used to refer to the same or similar elements or elements having the same or similar functions. The embodiments described below with reference to the drawings are exemplary, are intended to be illustrative of the disclosure and are not to be construed as limiting the disclosure.

Moreover, the terms “first” and “second” are used for descriptive purposes only and are not to be construed as indicating or implying a relative importance or implicitly indicating the number of technical features indicated. Thus, features defining “first” and “second” may comprise one or more of the features either explicitly or implicitly.

It should be understood that the orientation or positional relationship indicated by the terms “length”, “width”, “upper”, “lower”, “front”, “back”, “left”, “right”, “vertical”, “horizontal”, “top”, “bottom”, “inside”, “outside” and the like is based on the orientation or positional relationship shown in the drawings, and is merely for convenience of description of the disclosure and simplified description, rather than indicating or implying that the indicated device or component must have a particular orientation and must be configured and operated in a particular orientation, and thus is not to be construed as limiting the disclosure.

In the present disclosure, unless otherwise specifically stated and defined, the terms “installing”, “joining”, “connecting”, “fixing” and the like shall be understood broadly, and for example, may include a fixed connection or detachable connection or integration; may include mechanical connection or electrical connection; may include direct connection, or indirect connection through an intermediate medium, may include internal communication of two components or the interaction of two components. For those skilled in the art, the specific meanings of the above terms in the present disclosure can be understood depending on the circumstances.

The terms “comprising” and “having”, and any variations thereof, in the embodiments, are intended to cover a non-exclusive inclusion. The term “and / or” describes the association relationship between the associated objects, indicating that there may be three relationships, for example, A and/or B, meaning that: A exists alone without considering B, A and B coexist, B exists alone without considering A. The character “/” generally indicates that the front and back associated objects form an “or” relationship.

Further, in the description of the disclosure, the term “a plurality of” indicates two or more than two unless specifically defined otherwise.

### The First Embodiment

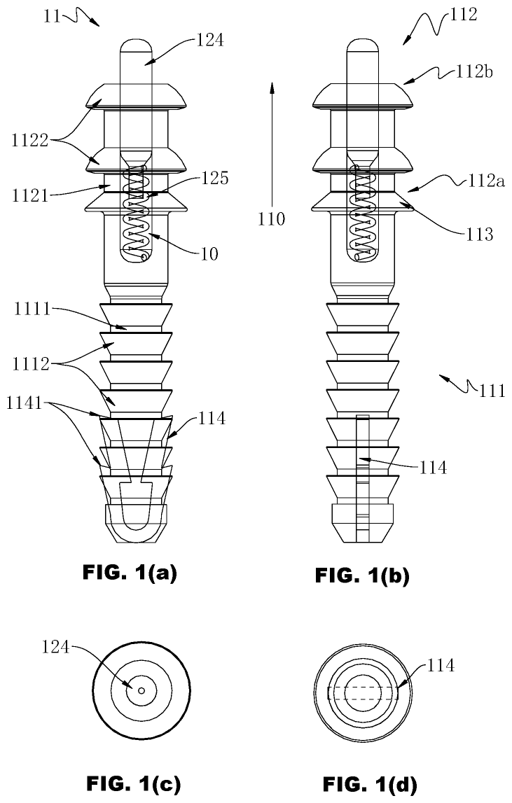

As shown in FIG. 1 to FIG. 8, a fastening assembly 1 provided in the embodiment can be used to replace a conventional connecting member such as a screw, a bolt, a glue or other commonly used connecting members on the market to securely connect an object to another object. In this embodiment, the fastening assembly 1 is used to connect the first installing member 2 and the second installing member 3, wherein the first installing member 2 and the second installing member 3 can be installing members of wood, plastic or other materials; the fastening assembly 1 comprises a sliding column 11 (in other embodiments, the sliding column 11 is also referred to as a fastener separately) and a sliding groove 12 for cooperating and clamping with each other; the sliding column 11 comprises a fixing portion 111 provided on the surface of the first installing member 2 facing the second installing member 3 and an extending portion 112 connected to the fixing portion 111, the extending portion 112 extends from the fixing portion 111 to the second installing member 3 in the first direction 110; and a sliding groove 12 is formed on a surface of the second installing member 3 facing the first installing member 2 and extends in the second direction 120, the sliding groove 12 has an avoiding space 121 for avoiding the second installing member 3 when the extending portion 112 is inserted into the sliding groove 12 in the first direction 110, a fastening space 122 for clamping the extending portion 112 to the sliding groove 12, and a limiting space 123 for limiting the extending portion 112 from extending from the avoiding space 121 to the fastening space 122 in the second direction 120, and the avoiding space 121, the limiting space 123 and the fastening space 122 are connected in sequence.

A sliding groove 12 is provided on the second installing member 3 by providing a sliding column 11 in the first installing member 2. When assembling the first installing member 2 and the second installing member 3, the user only needs to insert the sliding column 11 into the avoiding space 121 of the sliding groove 12 and slide to the fastening space 122 along the limiting space 123 so as to securely fix and limit it in the sliding groove 12. In the process, the first installing member 2 is translatable and slidable relative to the second installing member 3 under the drive of the sliding column 11, finally realizing the stable connection with the second installing member 3; accordingly, the user does not need other additional installation tools when assembling the first installing member 2 and the second installing member 3, the operation is simple, and the user installation process is not time-consuming or labor-intensive; the fastening assembly 1 can be hidden inside the first installing member 2 and the second installing member 3, that is, after the assembly is completed, the fastening assembly 1 is not visible inside the finished product, which improves the integrity and aesthetics of the finished product; at the same time, the fastening assembly 1 is provided so that the finished product quality does not vary from person to person, and the product is not easily damaged due to improper operation of the user; importantly, the structure ensures the connection stability of the finished product, prevents it from loosening over time, and prolongs the service life of the finished product.

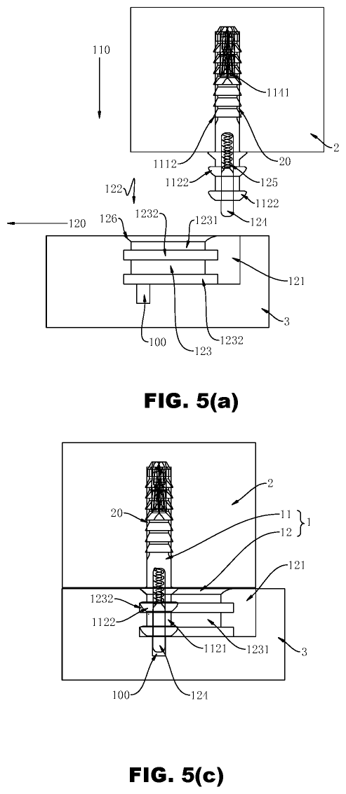

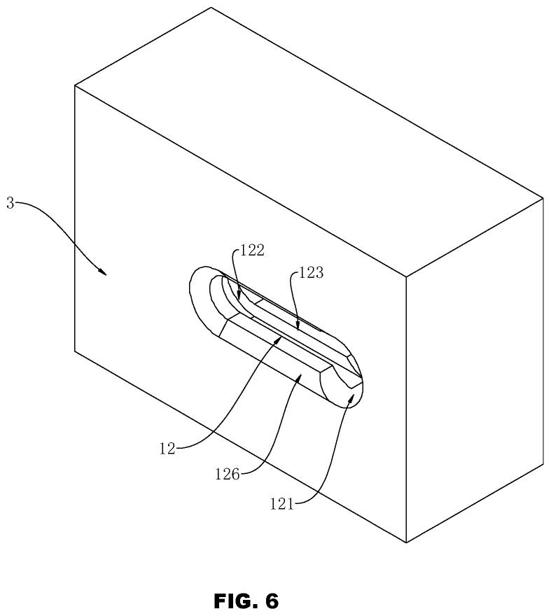

Furthermore, referring to FIG. 1(b), FIG. 5 and FIG. 7, as a specific embodiment of the fastening assembly 1 provided by the present application, the extending portion 112 has the first end 112a connected to the fixing portion 111 and the second end 112b opposite to the first end 112a, a receiving hole 10 is formed on the outer end surface of the second end 112b, the receiving hole 10 is provided with a locking pin 124 and an elastic member 125 through which the locking pin 124 is removed from the receiving hole 10 to the outer portion of the receiving hole 10; it should be noted that the elastic member 125 can be a coil spring, a spring piece, a leaf spring or other structure, which is not limited herein; the outer end surface of the second end 112b abuts against the bottom surface of the sliding groove 12 when the extending portion 112 slides in the sliding groove 12 to ensure the stability of the sliding process; the bottom surface of the fastening space 122 is formed with a locking hole 100, and the locking pin 124 is inserted into the locking hole 100 due to be being pushed by the elastic member 125 when the sliding column 11 is located in the fastening space 122; the structure is simple and easy to process, and it is ensured that the locking pin 124 can be reliably fixed to the fastening space 122 of the sliding groove 12 by the locking pin 124, and the fastening assembly 1 has good connection stability and a long service life of the assembled product.

In the present embodiment, referring to FIG. 1(a) and FIG. 1(b), the sliding column 11 comprises a locking pin 124 and an elastic member 125. The elastic member 125 is connected to the bottom of the locking pin 124. Specifically, the elastic member 125 can be a coil spring, the locking pin 124 can be provided in a cylindrical shape, and the elastic member 125 is sleeved on the positioning rod at the bottom of the locking pin 124. As shown in FIG. 1(a) and FIG. 1(b), the positioning rod of the locking pin 124 has a rod shape whose outer diameter is smaller than the diameter of the body of the locking pin 124. When the elastic member 125 is a coil spring, the outer diameter of the positioning rod is substantially equal to the inner diameter of the coil spring, and both of them are tightly connected.

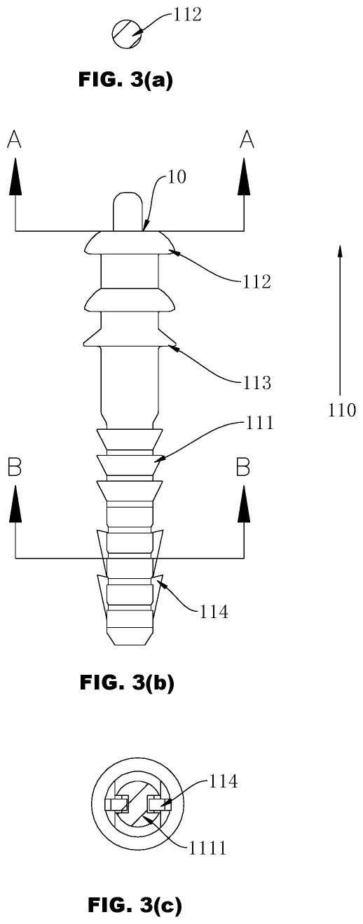

As shown in FIG. 3(a), the aperture of the receiving hole 10 at the top of the sliding column 11 may be slightly larger than the cross-sectional diameter of the locking pin 124 and the elastic member 125, while defining that the locking pin 124 can only move back and forth in the receiving hole 10 in the axial direction (110 direction in FIG. 1(a)), but does not generate displacement in a direction perpendicular thereto. The structure can ensure that the locking pin 124 and the elastic member 125 do not interfere with the side wall of the receiving hole 10 when sliding in the receiving hole 10, and ensure that the locking pin 124 protrudes from the top of the sliding column 11 by a certain distance when the locking pin 124 and the elastic member 125 are installed, and the top thereof may be flush with the top of the sliding column 11 when the locking pin 124 is compressed into the receiving hole 10. Alternatively, the elastic member 125 and the locking pin 124 are concentrically provided on the top of the sliding column 11, the top of the locking pin 124 can always be exposed outside the receiving hole 10 at this time, and the height of the exposed portion can be 2 mm to 10 mm, preferably 2 mm to 3 mm.

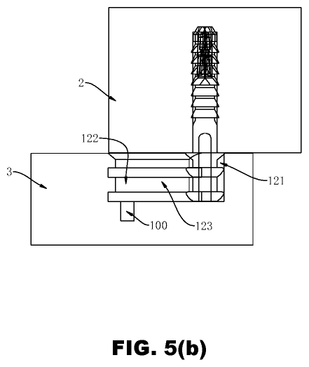

Furthermore, please refer to FIG. 6 and FIG. 7, the avoiding space 121 of the above sliding groove 12 is an inlet position in which the extending portion 112 enters the sliding groove 12, and the inlet position is located at one side of the sliding groove 12; the fixing space 122 of the sliding groove 12 is a position where the extending portion 112 is fastened in the sliding groove 12, the locking hole 100 located in the fastening space 122 communicates with the fastening space 122 and is located on the other side of the sliding groove 12; in the embodiment, the avoiding space 121 and the fastening space 122 are located on opposite sides of the sliding groove 12, the second direction 120 in which the extending portion 112 is slid is a linear direction at this time, the structure is easy to process and it is convenient for the user to assemble; of course, the second direction 120 can also be set to a direction of curved shape according to the actual situation, that is, the extending portion 112 can slide from the avoiding space 121 to the fastening space 122 along a curved path in the sliding groove 12, and the fastening space 122 can be provided at any position around the avoiding space 121. This structure is advantageous for reducing the extension length of the sliding groove 12, and is applicable when the second installing member 3 is small in volume.

Referring to FIG. 1 to FIG. 5, as a specific embodiment of the fastening assembly 1 provided by the disclosure, the extending portion 112 has an extending body 1121 and a protruding portion 1122 convexly provided on the outer wall of the extending body 1121, and the extending body 1121 extends along the first direction 110; the limiting space 123 comprises the first limiting groove 1231 in which the extending body 1121 slides and the second limiting groove 1232 in which the protruding portion 1122 slides. The first limiting groove 1231 and the second limiting groove 1232 are connected to each other.

Further, as a specific embodiment of the fastening assembly 1 provided by the disclosure, the extending body 1121 has a cylindrical shape, the first direction 110 is parallel to the axial direction of the extending body 1121 and is vertical to the surface of the first installing member 2 facing the second installing member 3; further, as a specific embodiment of the fastening assembly 1 provided by the disclosure, there are a plurality of the protruding portions 1122, the plurality of protruding portions 1122 are substantially hemispherical or boss-shaped and are provided on the extending body 1121 in the first direction 110 at intervals, and the extending body 1121 is provided coaxially with the plurality of protruding portions 1122.

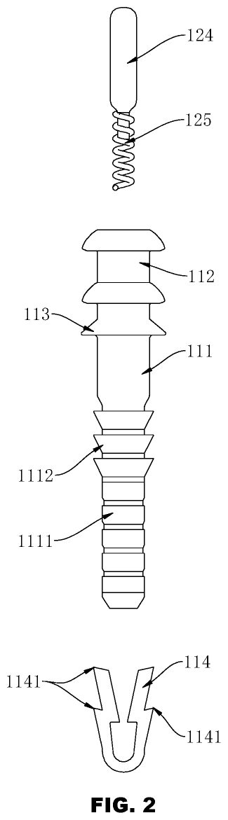

Specifically, please refer to FIG. 1 to FIG. 2, there may be two protruding portions 1122 on the extending portion 112, one of the protruding portions 1122 may be provided at the top of the extending body 1121, and the other of the protruding portions 1122 is provided in the middle of the extending body 1121. The two protruding portions 1122 are hemispherical or boss-shaped, preferably hemispherical. It should be understood that “hemispherical” or “boss-shaped” as used herein further comprises a portion taken along two parallel planes in a direction perpendicular to the diameter of the sphere (or a direction perpendicular to the height of the boss). When the extending body 1121 protrudes into the sliding groove 12, the two protruding portions 1122 are slidably inward along with the extending body 1121, and there will be friction between the outer peripheral flanges of the two hemispherical protruding portions 1122 and the inner wall of the sliding groove 12, so that the connection between the extending portion 112 and the sliding groove 12 is achieved by the friction therebetween; the process in which the extending body 1121 extends into the sliding groove 12 may be realized in such a way that the user screws or translates the sliding column 11 into the sliding groove 12, and of course can also be realized by other operational forms.

Referring to FIG. 1 to FIG. 5, as a specific embodiment of the fastening assembly 1 provided by the disclosure, the fixing portion 111 has a fixing body 1111 and a plurality of pulling rings 1112, the fixing body 1111 extends in the first direction 110 and is inserted into a receiving groove 20 of the first installing member 2, and the plurality of pulling rings 1112 are provided on the fixing body 1111 at equal intervals in the first direction 110 and abuts against the groove walls of the receiving groove 20, respectively, so as to limit the fixing body 1111 withdrawn from the receiving groove 20.

Further, as a specific embodiment of the fastening assembly 1 provided by the disclosure, the sliding column 11 further comprises a limiting portion 113 located between the fixing portion 111 and the extending portion 112 for limiting the extending portion 112 from entering the receiving groove 20; specifically, the limiting portion 113 can be tapered or boss-shaped. After the limiting portion 113 is provided so that the sliding column 11 enters the sliding groove 12 for a certain distance, the limiting portion 113 can limit the distance by which the extending portion 112 enters the avoiding space 121 by the circumferential flange thereof and ensure the precise size of the extending portion 112 entering the sliding groove 12; a limiting bevel 126 corresponding to the limiting portion 113 is formed at the notch of the sliding groove 12 so that the limiting bevel 126 can be engaged and clamped with the limiting portion 113 on the one hand, and no burr can be left around the notch of the sliding groove 12 on the other hand, and the limiting portion 113 can also smoothly move on the limiting bevel 126; the structural design is reasonable, and it is convenient for the user to operate.

Furthermore, as a specific embodiment of the fastening assembly 1 provided by the disclosure, each of the pulling rings 1112 is boss-shaped and is provided around the outer circumference of the fixing body 1111. Specifically, in the embodiment, there are eight pulling rings 1112, and the maximum cross-sectional diameter of the eight pulling rings 1112 may be slightly larger than the cross-sectional diameter of the fixing body 1111 to ensure that the fixing portion 111 is stably fixed in the receiving groove 20 on the first installing member 2 and has a high structural strength.

Preferably, as shown in FIG. 2, the hemispherical protruding portions 1122 on the extending portion 112 are all arranged on the extending body 1121 with a narrow upper part and a wide lower part. The pulling rings 1112 on the fixing portion 111 are all arranged on the fixing body 1111 with a wide upper part and a narrow lower part. The protruding portion 1122 and the pulling ring 1112 are arranged in reverse directions, which is beneficial to improving the structural stability that the sliding column 11 is fixed inside the first installing member 2 and the second installing member 3, so that it is not easy for the sliding column 11 to be pulled out from the first installing member 2, and is not easy to be pulled out from the second installing member 3. The structural arrangement is reasonable and the connection strength is high.

Preferably, as a specific embodiment of the fastening assembly 1 provided by the disclosure, the fixing portion 111 further has an elastic body 114 provided on the fixing body 1111 and/or the pulling ring 1112, and the elastic body 114 has at least two elastic arms 1141 abutting against the groove wall of the receiving groove 20. Alternatively, the elastic body 114 may be a leaf spring, a rubber ring, or the like. Preferably, the elastic body 114 has a barbed end (referring to FIG. 2); in the embodiment, referring to FIG. 2 to FIG. 4, the elastic body 114 may be provided at the bottom of the fixing portion 111; after inserting the fixing portion 111 into the receiving groove 20 of the first installing member 2, the elastic arm 1141 of the elastic body 114 can be opened and then the two barbs thereof are firmly attached to the side of the receiving groove 20, so that the fixing portion 111 is more stably provided in the receiving groove 20. The process is specifically such that when the fixing portion 111 enters the receiving groove 20, the elastic body 114 is compressed, that is to say, the elastic arm 1141 thereof is always in a compressed state and is attached to the inner wall of the receiving groove 20. When the user applies a pulling force to the sliding column 11, the fixing portion 111 moves outward, and at this time, the elastic arm 1141 is still attached to the groove wall of the receiving groove 20 and limits the fixing portion 111 from being pulled out by the frictional force.

The structure can ensure that the fixing portion 111 can be fixed in the receiving groove 20 to the utmost extent. In particular, when the first installing member 2 is made of a material such as wood and plastic that has a very smooth inner wall of the receiving groove 20, the fixing portion 111 may be easily pulled out of the receiving groove 20 only depending on the pulling ring 1112. The structural stability of the fixing portion 111 with respect to the first installing member 2 can be ensured by providing the elastic body 114 having the elastic arm 1141.

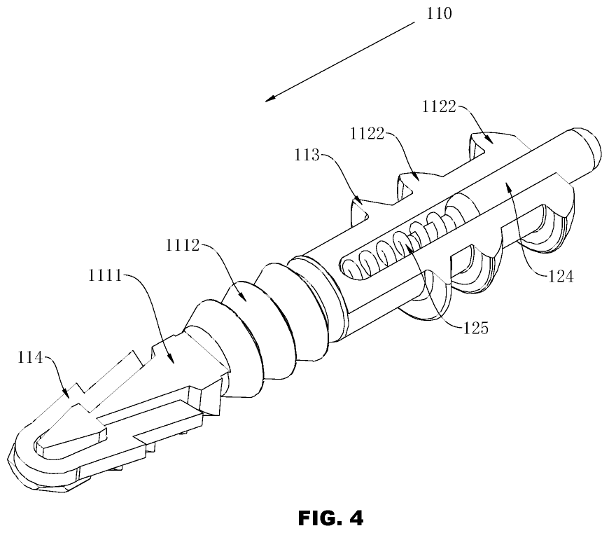

FIG. 2 illustrates the specific structure of the elastic body 114 and at least two elastic arms 1141 thereof. The elastic body 114 can be in the form of a plate. The elastic body 114 has two elastic arms 1141 on each side, and the two elastic arms 1141 at the same side can be stepped. The cross-sectional shape of the entire elastic body 114 is V-shaped, and may be an integrally formed member; the angle between the elastic arms 1141 at both sides of the elastic body 114 may be provided according to actual conditions, which is not limited herein; the shape of the elastic arms 1141 can also be reset according to the material of the first installing member 2. As shown in FIG. 4, the elastic body 114 can be sleeved at the bottom of the fixing body 1111. The specific sleeve manner can be not limited to the manner in FIG. 4; the sleeve manner can ensure the structural stability between the elastic body 114 and the fixing body 1111, and prevent the elastic body 114 from being detached from the bottom of the fixing body 1111.

The present embodiment further provides an assembling member, which may specifically be furniture, a shelf, a display cabinet, or the like made of wood or plastic. The assembling member may comprise the first installing member 2, the second installing member 3 and the above fastening assembly 1. The sliding column 11 is provided on the first installing member 2, and the sliding groove 12 is formed on the second installing member 3. The sliding column 11 is inserted from the avoiding space 121 and slides to the fastening space 122 through the limiting space 123 to drive the first installing member 2 to translate relative to the second installing member 3 and abut against the second installing member 3.

It should be noted that the first installing member 2 on which the sliding column 11 is provided and/or the second installing member 3 on which the sliding groove 12 is formed may be referred to as an assembling member, that is to say, all three products should be protected object of the solution of the embodiment.

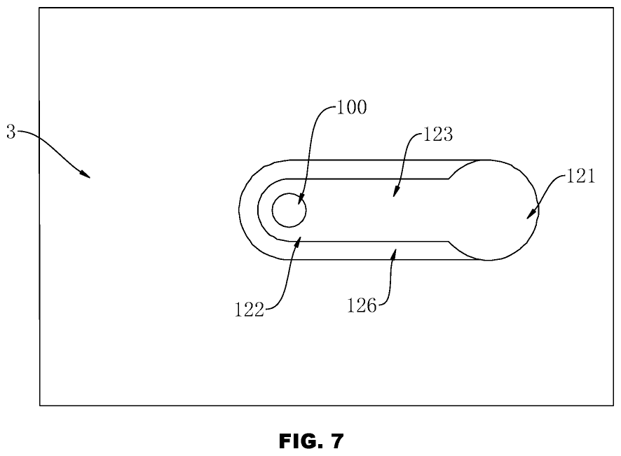

As shown in FIG. 8, the two methods of detaching and removing the sliding column 11 from the second installing member 3 can be as follows.

1. The locking pin 124 (magnetic metal material) is sucked out of the locking hole 100 using a magnetically adsorbing assembly 6, thereby allowing the extending portion 112 to return from the fastening space 122 to the avoiding space 121 of the sliding groove 12 and to be removed.

2. The locking pin 124 is pushed out from the preset locking hole 100 using a small-diameter push rod 5, and the passage pushed by the push rod 5 can communicate with the locking hole 100. Once the locking pin 124 is pushed out of the locking hole 100, the extending portion 112 can be returned from the fastening space 122 to the avoiding space 121 of the sliding groove 12 and is removed.

The above two methods are easy to implement, simple in operation, timesaving and labor-saving. Of course, the method for removing the fastening assembly 1 is not limited to the above two methods, and may be other methods, which are not limited herein.

### The Second Embodiment

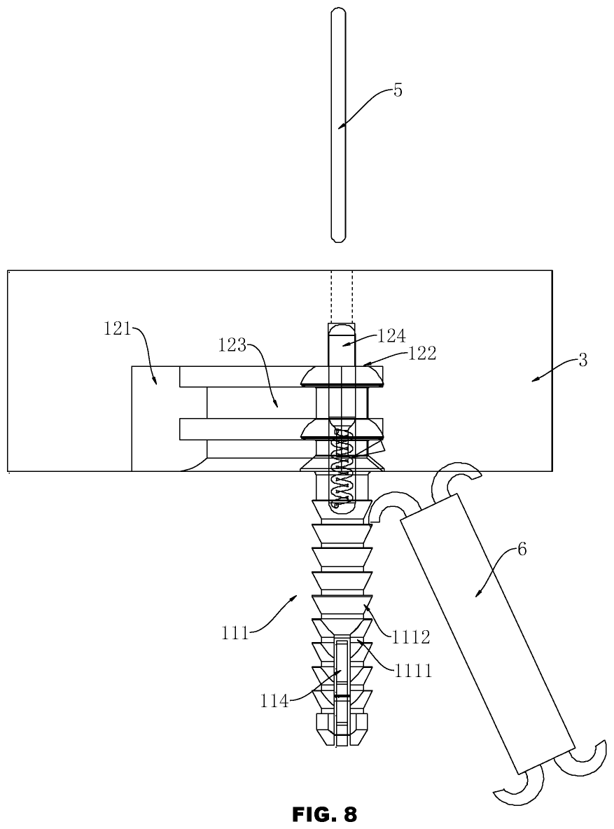

The differences from the above embodiment will be described in detail below with reference to FIGS. 9 to 11.

The extending portion 112 of the fastening assembly 1 of the present embodiment can be configured in the same manner as the above embodiment. As a specific embodiment of the fastening assembly 1 provided by the present disclosure, the fixing portion 111 of the fastener (i.e., the sliding column in the first embodiment) extends in the first direction 110 and is mirrored to the extending portion 112. The mirror structure is specifically shown in FIG. 9(a); the fixing portion 111 is located in the fixing groove 200, and the fixing groove 200 is formed on the surface of the first installing member 2 facing the second installing member 3 and has a notch shape corresponding to the sliding groove 12. In other words, the fixing groove 200 and the sliding groove 12 may be identical in structure.

The fastening assembly 1 of the embodiment can be connected to two oppositely provided panels, i.e., the first installing member 2 and the second installing member 3 are provided opposite to each other and have a completely identical groove structure thereon. After the user connects the sliding column 11 to the opposite panel, the two panels can be closely fitted without any connecting members such as adhesives or screws; at the same time, the fastening assembly 1 is located inside the two panels, and the connection structure therebetween is not visible from outside.

Alternatively, two opposite tapered structures are in the middle of the sliding column 11, and the structures have a limiting function.

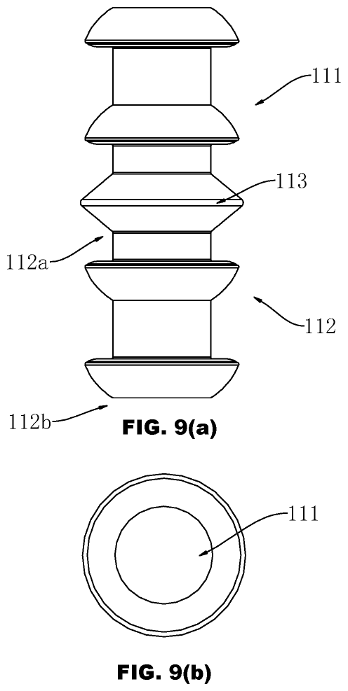

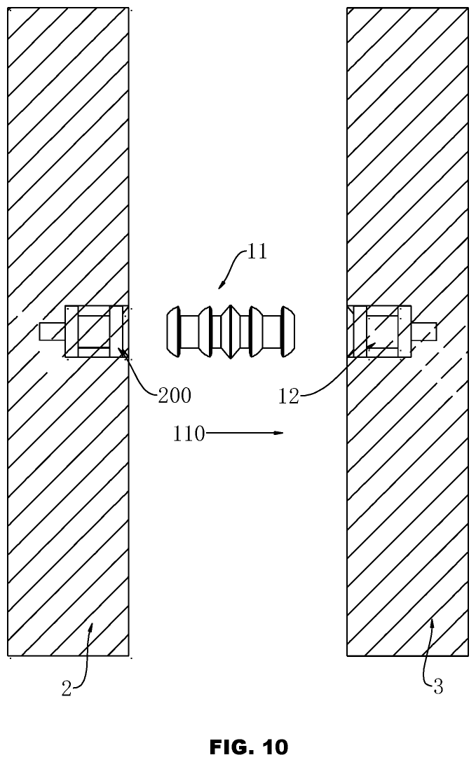

FIG. 10 and FIG. 11 illustrate how the second installing member 3 and the second installing member 3 are fastened by the sliding column 11 according to the present embodiment. The structure is reasonable, it is easy for the user to operate, the overall appearance of the assembling member is good, the strength is high, and the user experience and the user viscosity of the assembling member product are improved.

### The Third Embodiment

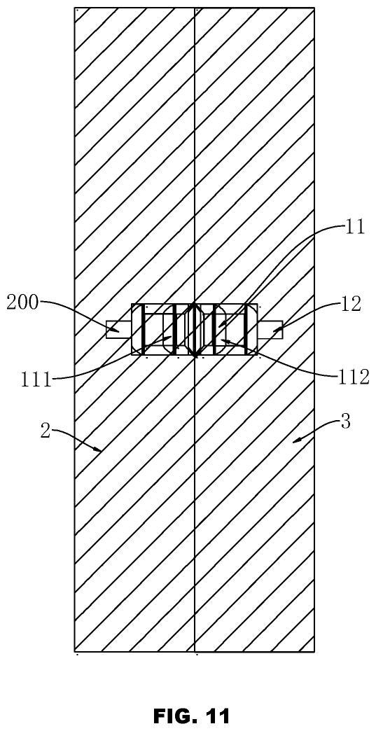

Hereinafter, only differences from the above embodiments will be described in detail with reference to FIGS. 12 to 14.

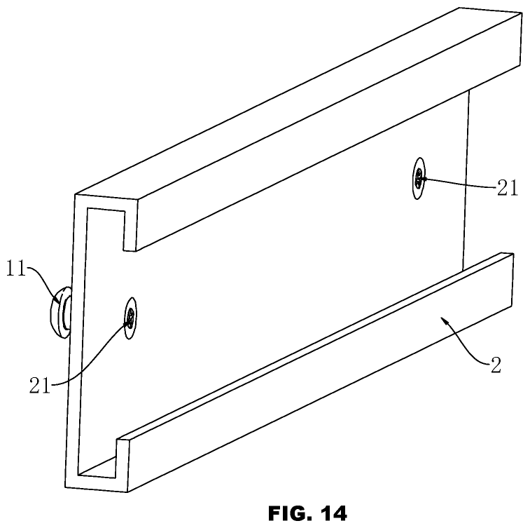

The extending portion 112 of the fastener of the present embodiment may be configured in the same manner as the above embodiments. As a specific embodiment of the fastening assembly 1 provided by the disclosure, the screw locking hole 115 corresponding to the through hole 210 on the first installing member 2 is formed on the end surface of the extending portion 112 facing away from the fixing portion 111, and the fixing portion 111 is lockedly connected to the first installing member 2 by a screw 21; wherein the fixing portion 111 of the sliding column 11 can have a hexagonal cross-sectional shape; it should be noted that at least one sliding column 11 can be installed on the first installing member 2. FIG. 14 is exemplified by two examples.

The fastening assembly 1 of the embodiment can attach the sliding column 11 to the first installing member 2 at the beginning of assembly, where the first installing member 2 is, but not limited to, a drawer slide, a hinge, a bracket, a roller, and an adjustable bracket or the like; the user can also screw the screw 21 into the through hole 210 and the screw locking hole 115 by a wrench to assemble the sliding column 11 and the first installing member 2. After the sliding column 11 is connected to the first installing member 2, the first installing member 2 can be directly installed on the second installing member 3 without other connecting members such as screws and bolts, and the user can directly make connection using bare hands without any other tools or adhesives.

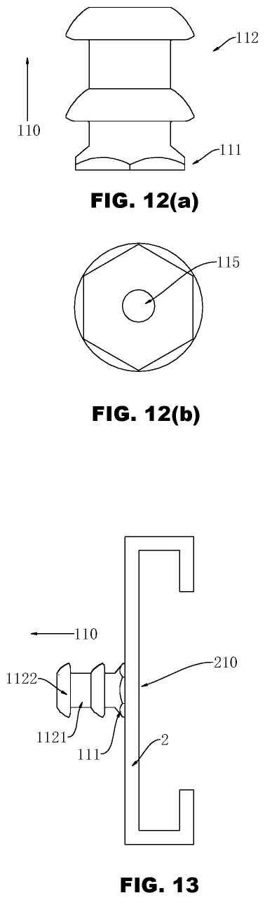

FIG. 13 further illustrates the manner in which the sliding column 11 is connected and the position where the hexagonal fixing portion 111 is on the first installing member 2. FIG. 14 illustrates a structure in which the fixing portion 111 is lockedly connected to the first installing member 2 by screws 21.

In summary, the three embodiments can all realize the connection between the first installing member 2 and the second installing member 3. The specific connection between the first installing member 2 and the second installing member 3 can be: the fitted connection between the panel and the panel surface, objects of some type, such as drawer slides, hinges, knobs, baskets, etc., connection such as attached to the panel surface, and the like.

The fastening assembly and fastener of the disclosure can be both used for furniture products such as wardrobes, tables, chairs, dressing tables, closets, doors and windows, etc., and can also be used for part of the structure of furniture, such as drawers, cabinet doors, etc.

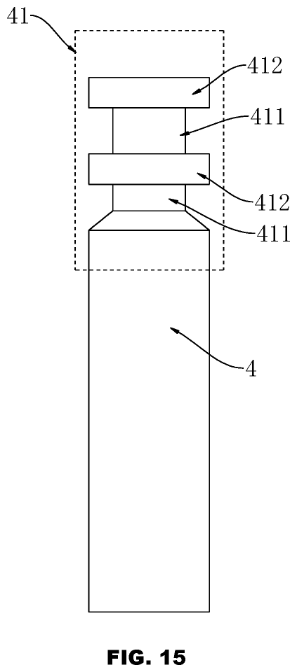

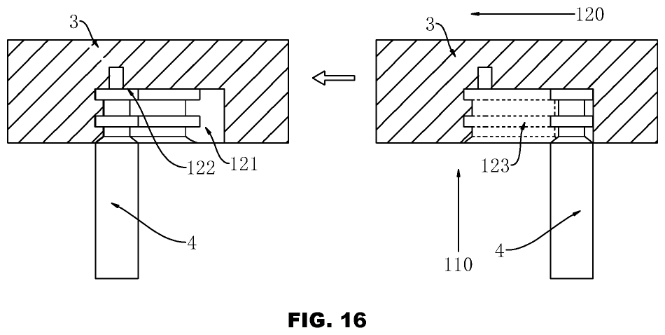

As shown in FIG. 15 to FIG. 16, a router tool 4 further provided by the present embodiment is, but is not limited to, a dadoing drill bit for processing the sliding groove 12 provided in the above embodiments, comprising a cutting portion 41. The cutting portion 41 is inserted into the second installing member 3 in the first direction 110 and is translated and cut in the second direction 120 to form the sliding groove 12 on the surface of the second installing member 3; the cutting portion 41 has the first cutting edge 411 for processing the limiting groove 1231 and the second cutting edge 412 for processing the second limiting groove 1232, the first cutting edge 411 has a cutting edge shape corresponding to the cross-sectional shape of the extending body 1121, and the second cutting edge 412 has a cutting edge shape corresponding to the cross-sectional shape of the protruding portion 1122.

Specifically, the router tool 4 may also have a corresponding cutting edge for forming a limiting bevel 126. The limiting bevel 126 can cause the sliding column 11 to be less resisted when moving from one end to the other end of the sliding groove 12 and no burr structure is made at the notch edge of the sliding groove 12.

Continuing to refer to FIG. 16, the sliding groove 12 processed by the router tool 4 should ensure that the sliding column 11 does not have any resistance when entering the avoiding space 121 of the sliding groove 12, and the position and the cutting edge shape of each cutting edge of the router tool 4 are should be both adapted to the structure of the sliding groove 12. After the processing of the avoiding space 121, the limiting space 123 and the fastening space 122 is completed, the locking hole 100 can be separately processed by another tool, and the diameter of the locking hole 100 can be slightly larger than the diameter of the locking pin 124 on the sliding column 11; thus, the processing of the sliding groove 12 and the locking hole 100 can be completed. The router tool 4 is simple in structure and is convenient to produce and process, available for providing sliding grooves 12 in batches in various second installing members 3, strong in universality and high in production efficiency.

It should be noted that the solution in another specific embodiment described above may be an embodiment further improved on the basis of other embodiments. The technical features of the above embodiments may be arbitrarily combined. For the sake of brevity of description, all possible combinations of the technical features in the above embodiments are not described. However, as long as there is no contradiction between the combinations of these technical features, all the combinations should be considered as the scope described in the specification.

The above embodiments of the disclosure are intended to be illustrative merely of the embodiments of the disclosure, rather than limit the embodiments of the disclosure. Other variations or modifications of the various forms may be made by those skilled in the art in light of the above description. There is no need and no way to exhaust all of the implementations. Any modifications, equivalent substitutions and improvements made within the spirit and principle of the disclosure are intended to be included within the scope of the appended claims.

### LIST OF REFERENCE SYMBOLS

The various reference numerals in the figures are as follows:

1: a fastening assembly

2: the first installing member

3: the second installing member

4: a router tool

5: a push rod

6: a magnetically adsorbing assembly

10: a receiving hole

11: a sliding column

12: a sliding groove

20: a receiving groove

21: a screw

41: a cutting portion

100: a locking hole

110: the first direction

111: a fixing portion

112: an extending portion

112a: the first end

112b: the second end

113: a limiting portion

114: an elastic body

115: a screw locking hole

120: the second direction

121: an avoiding space

122: a fastening space

123: a limiting space

124: a locking pin

125: an elastic member

126: a limiting bevel

200: a fixing groove

210: a through hole

411: the first cutting edge

412: the second cutting edge

1111: a fixing body

1112: a pulling ring

1121: an extending body

1122: a protruding portion

1141: an elastic arm

1231: the first limiting groove

1232: the second limiting groove

What is claimed is:

1. A fastening assembly for connecting a first installing member and a second installing member, the fastening assembly comprising:
a sliding column comprising a fixing portion provided on a surface of the first installing member facing the second installing member, and an extending portion connected to the fixing portion, wherein the extending portion extends to the second installing member; and
a sliding groove for engaging and clamping with the extending portion, wherein the sliding groove is formed on a surface of the second installing member facing the first installing member, the sliding groove comprises an avoiding space for inserting the extending portion into the sliding groove, a fastening space for clamping the extending portion to the sliding groove, and a limiting space for limiting the extending portion from extending from the avoiding space to the fastening space, wherein a bottom surface of the fastening space is formed with a locking hole, and the avoiding space, the limiting space, and the fastening space are connected in sequence.

2. The fastening assembly of claim 1, wherein:
the extending portion comprises a first end connected to the fixing portion and a second end opposite to the first end,
a receiving hole is formed on the outer end surface of the second end, the receiving hole being provided therein with a locking pin and an elastic member for partially moving the locking pin outside of the receiving hole,
the outer end surface of the second end abuts against the bottom surface of the sliding groove when the extending portion slides in the sliding groove, and
the locking pin is inserted into the locking hole under the pushing of the elastic member when the sliding column is located in the fastening space.

3. The fastening assembly of claim 1, wherein:
the extending portion comprises an extending body and a protruding portion convexly provided on the outer wall of the extending body,
the limiting space comprises a first limiting groove in which the extending body slides and a second limiting groove in which the protruding portion slides, and
the first limiting groove and the second limiting groove are connected to each other.

4. The fastening assembly of claim 3, wherein:
the extending body is cylindrical and has a plurality of the protruding portions disposed thereon at intervals in axial direction thereof,
each protruding portion is hemispherical, and
the extending body and the plurality of protruding portions are arranged coaxially.

5. The fastening assembly of claim 1, wherein the fixing portion comprises a fixing body and a plurality of pulling rings, and the fixing body is inserted into a receiving groove of the first installing member, the plurality of pulling rings are disposed on the fixing body at equal intervals in axial direction of the fixing body and respectively abuts against the groove walls of the receiving groove, so as to limit the fixing body withdrawn from the receiving groove.

6. The fastening assembly of claim 5, wherein:
the sliding column further comprises a limiting portion which is located between the fixing portion and the extending portion for limiting the extending portion from entering the receiving groove,
a limiting bevel corresponding to the limiting portion is formed at the notch of the sliding groove.

7. The fastening assembly of claim 5, wherein each of the pulling rings is boss-shaped and is disposed around an outer circumference of the fixing body.

8. The fastening assembly of claim 5, wherein:
the fixing portion further comprises an elastic body disposed on the fixing body and/or the pulling ring, and
the elastic body comprises at least two elastic arms that abut against the groove wall of receiving groove.

9. The fastening assembly of claim 1, wherein:
the fixing portion and the extending portion mirror each other,
the fixing portion is located in the fixing groove, and
the fixing groove is formed on a surface of the first installing member facing the second installing member.

10. The fastening assembly of claim 1, wherein:
a screw locking hole corresponding to the through hole on the first installing member is formed on the end surface of the extending portion facing away from the fixing portion, and
the fixing portion is lockedly connected to the first installing member by a screw.

11. A fastener comprising:
an extending portion, wherein the extending portion comprises an extending body and a protruding portion convexly provided on the outer wall of the extending body, a first end for connecting with another extending portion or a fixing portion or a screw, and a second end opposite to the first end;
a receiving hole formed on the outer end surface of the second end, the receiving hole being provided therein with a locking pin capable of moving along the length direction of the receiving hole.

12. The fastener of claim 11, wherein the receiving hole is further provided with an elastic member for partially moving the locking pin outside of the receiving hole.

13. The fastener of claim 11, wherein the fastener comprises two extending portions which are arranged in mirror symmetry.

14. The fastener of claim 11, wherein the fastener comprises an extending portion and a fixing portion connected to the first end of the extending portion, and the fixing portion comprises a fixing body and a plurality of pulling rings.

15. The fastener of claim 11, wherein the fixing portion further comprises an elastic body arranged on the fixing body and/or the pulling ring, and the elastic body comprises at least two barbed elastic arms.

16. A router tool for processing a sliding groove, the router tool comprising:
a cutting portion configured to insert into the second installing member in a first direction and translate and cut the second installing member in a second direction to form the sliding groove on a surface of the second installing member, and the sliding groove is configured to be engaged and clamped with the extending portion in the fastener of claim 11;
the cutting portion comprises a first cutting edge for processing the first limiting groove and a second cutting edge for processing the second limiting groove, the first cutting edge has a cutting edge shape corresponding to a cross-sectional shape of the extending body, and the second cutting edge has a cutting edge shape corresponding to a cross-sectional shape of the protruding portion.
